(19) United States
(12) Patent Application Publication
(10) Pub. No.: US 2026/0286767 A1
(43) Pub. Date: Sep. 24, 2026

(54) CLIP APPARATUS

(71) Applicant: STORM ARMOUR, INC., Miami Beach, FL (US)

(72) Inventors: Mark Fisher, Bal Harbour, FL (US); Todd Michael Glaser, Palm Beach, FL (US); Ronald Simkins, Miami, FL (US); David Kreps, Miami Beach, FL (US); Werner Blumenthal, Miami, FL (US)

(73) Assignee: STORM ARMOUR, INC., Miami Beach, FL (US)

(21) Appl. No.: 19/087,233

(22) Filed: Mar. 21, 2025

(51) Int. Cl. E06B 7/26; E06B 3/46

(52) U.S. Cl. CPC E06B 7/26; E06B 3/46

(57) ABSTRACT

A lightweight, compact, modular, and reusable clip apparatus, that provides for the secure attachment of a rain deflector to a sliding glass door or window track rail. The clip apparatus configured to attach a rain deflector to a track rail. The clip apparatus includes a jaw portion having two jaw halves. The jaw potion is configured with a receiving, or clamping, geometry that is shaped to securely clip over and receive a track rail. By way of example and not limitation, these track rails may have a button or mushroom-shaped extruded profile and the jaw receiving portion preferably also has surfaces configured to receive and securely clip around and onto that profile. Embodiments of the clip apparatus are further configured with a receiver. This receiver is adapted to securely attach the clip apparatus to another structure, apparatus, or device

### CROSS-REFERENCE TO RELATED APPLICATIONS

None.

### FIELD OF THE INVENTION

The present invention generally relates to clip devices and, more specifically, to an improved apparatus for the easy and secure attachment of modular rain and wind mitigation devices that aid in the reduction of small debris and water intrusion through sliding glass door tracks during severe weather conditions.

### BACKGROUND OF THE INVENTION

In high rise condominiums, townhouses, apartment buildings, and private residences there are no current practical and/or efficient ways to reduce the amount of water intrusion through sliding glass doors, and their tracks, during severe weather. Hurricane rated or not, most sliding glass doors slide on tracks that are built with weep holes, which allow accumulated water to drain out under normal weather condition. This is not the case in conditions with wind-driven rain. Under these severe conditions, weep holes do not function properly as the storm-force winds push the rainwater through the gaps between the sliding glass door and the track into the interior of the structure. Commonly owned patent applications U.S. Ser. Nos. 17/428,113, 17/994,231, 18/416,241 and family applications and granted patents, are a marked improvement over the existing state of the art and could further benefit from an improved apparatus for the attachment and retention of said wind and rainstorm intrusion mitigation devices to existing structures such as, but not limited to, sliding door and window tracks and rails.

It would be advantageous, then, to have a device that facilitates the quick and easy installation of rain deflectors while also being securable and easily removable when not in use.

There is a need, therefore, for a lightweight, compact device that provides a simple and easy attachment method to securely attach rain deflectors to the rails of sliding glass doors and windows for customized installations.

### SUMMARY OF THE INVENTION

We disclose a lightweight, compact, modular, and reusable device, that provides for the secure attachment of a rain deflector to a sliding glass door or window track rail. The apparatus is designed to be used in conjunction with, at least, the track foam barriers and related systems disclosed in commonly owned and co-pending U.S. patent application Ser. Nos. 17/428,113, 17/994,231, and 18/416,241. This disclosure includes improvements to the apparatus and system disclosed in this family of commonly owned and co-pending U.S. Patent Applications, all of which are incorporated by reference herein in their entireties.

In embodiments, we disclose a clip apparatus configured to attach a rain deflector to a track rail. The clip apparatus includes a jaw portion having two jaw halves. The jaw potion is configured with a receiving, or clipping, geometry that is shaped to securely clip over and receive a track rail. By way of example and not limitation, these track rails may have a button or mushroom-shaped extruded profile and the jaw receiving portion preferably also has surfaces configured to receive and securely clip around and onto that profile.

Embodiments of the clip apparatus are further configured with a receiver. This receiver is adapted to securely attach the clip apparatus to another structure, apparatus, or device, such as but not limited to the rain deflector shown and described in U.S. patent application Ser. No. 18/416,241. In preferred embodiments, the receiver is a female extruded portion of the clip configured to receive a male protrusion from the rain deflector in inserted relation. In further embodiments, the receiver may also be configured to allow for a degree of movement, or adjustment, between the clip apparatus and the rain deflector, be it angular, rotational, or longitudinal movement relative to the clip and rain deflector apparatuses.

In yet further embodiments, the clip apparatus includes a biasing force element, such as but not limited to a torsion spring, that applies a biasing force such that the clip jaws are in a normally closed aspect or position. A counter force may be applied to open the jaws for insertion or removal. Additionally, the clip apparatus may include a locking element configured to lock or unlock the clip selectively between the open or closed aspect or position.

Other embodiments include lead-in features on the jaw portion of the clip that are configured to accommodate “pressing” the clip onto a rail. In this embodiment, the clip does not need to be “opened” but rather, the lead-in features are configured such that the rail geometry spreads open the jaw halves as the clip apparatus is pressed down over the rail.

Although the invention is illustrated and described herein as embodied in a device for the attachment of rain deflectors to track rails, the invention should not be limited to the details shown in those embodiments because various modifications and structural changes may be made without departing from the spirit and scope of the invention. Furthermore, while the invention is described within the context of a sliding glass door system, one of ordinary skill in the art will realize that the invention may be sized and configured as appropriate for other applications such as, but not limited to, windows, sliding doors without glass, and other similar components or structures.

The construction and method of operation and installation of the invention and additional objects and advantages of the invention are best understood from the following description of specific embodiments when read in connection with the accompanying drawings.

### BRIEF DESCRIPTION OF THE DRAWINGS

In the accompanying figures, like reference numerals refer to identical or functionally similar elements throughout the separate views. The accompanying figures, together with the detailed description below, are incorporated in and form part of the specification and serve to further illustrate various embodiments and to explain various principles and advantages all in accordance with the present invention, in which:

FIG. 1 shows an isometric view in an open configuration according to an embodiment;

FIG. 2 shows the apparatus of FIG. 1 in a closed configuration;

FIG. 3 shows an exploded isometric view of the apparatus shown in FIG. 1;

FIG. 4a shows a top view of the apparatus shown in FIG. 1 in a closed configuration;

FIG. 4b shows a cross-sectional view of the apparatus shown in FIG. 4a;

FIG. 5a shows a top view of the apparatus shown in FIG. 1 in an open configuration;

FIG. 5b shows a cross-sectional view of the apparatus shown in FIG. 5a;

FIG. 6 shows a side profile view of the invention shown in FIG. 1, as installed in a simplified representative environment;

FIG. 6a shows a detailed view of FIG. 6;

FIG. 7 shows an isometric view of the apparatus according to another embodiment;

FIG. 8 shows a side view of FIG. 7 in a closed configuration;

FIG. 9 shows a side view of FIG. 7 in an open configuration;

FIG. 10 shows an exploded isometric view of the apparatus shown in FIG. 7;

FIG. 11 shows a side profile view of the invention shown in FIG. 7, as installed in a simplified representative environment; and

FIG. 11a shows a detailed view of FIG. 11.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

The present disclosure is not a literal description of all embodiments of the invention. Also, the present disclosure is not a listing of features of the invention which must be present in all embodiments. Furthermore, various figures depict structures such as doors, glass, tracks, panels, sills, frames, and floors in order to show the invention in a representative installation environment and for context. These structures are depicted for reference only and, unless otherwise expressly claimed, form no part of the invention and are not intended to limit the scope of the claims in any way.

### Non-Limiting Definitions

The title of the present application and headings of sections provided in the present application are for convenience only, and are not to be taken as limiting the disclosure in any way.

In this specification and in the appended claims and drawings, words and phrases have the meanings commonly attributed to them in the relevant art except as otherwise specified herein. The terminology used herein is for the purpose of describing particular embodiments only and is not intended to be limiting of the disclosure.

The following non-limiting definitions are provided as a guide to interpreting the present invention:

The terms “a”, “an” and “the” mean “one or more”, unless expressly specified otherwise. As used herein, the singular forms “a”, “an” and “the” are intended to include the plural forms as well, unless the context clearly indicates otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. . . . when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g.,, 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

The terms “including”, “comprising” and variations thereof mean “including but not limited to”, unless expressly specified otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “product” means any machine, manufacture, and/or composition of matter, unless expressly specified otherwise.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein. While certain aspects of conventional technologies and methods in the relevant art have been discussed to facilitate disclosure of the invention, Applicant in no way disclaims these technical aspects or methods, and it is contemplated that the claimed invention may encompass one or more of the conventional technical aspects or methods discussed herein.

Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Specifically, component names, types, and values, as depicted in the exemplary schematic diagrams, are not intended to limit the scope of the present invention and are presented only as possible embodiments.

### Clip Apparatus 100

We disclose an inventive clip that is an improvement over the prior art and adds novel features and functionality to the rain deflector apparatus and system disclosed in commonly owned and co-pending U.S. patent application Ser. No. 18/416,241. The inventive clip apparatus may be used singly, or in combination with multiple clips as needed to correspond to the number or length of rain deflectors to be secured in an installation.

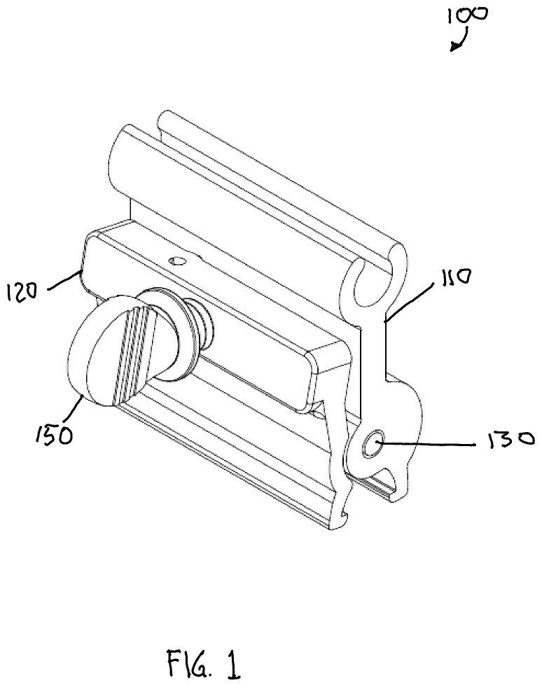

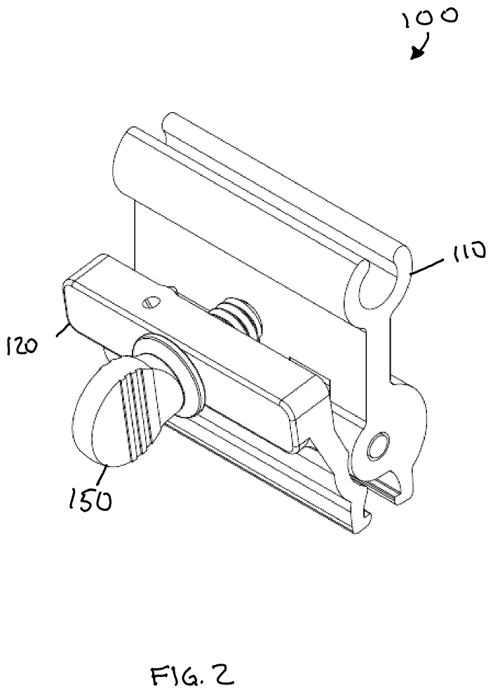

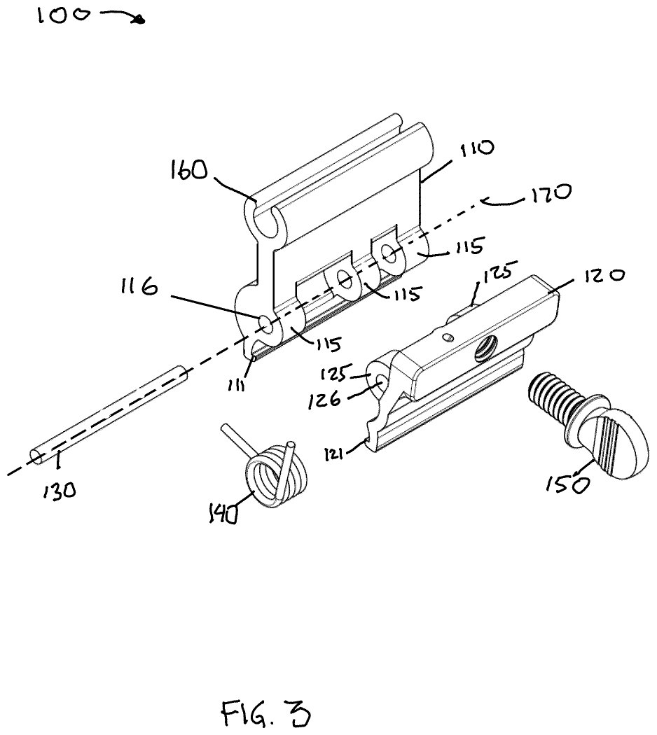

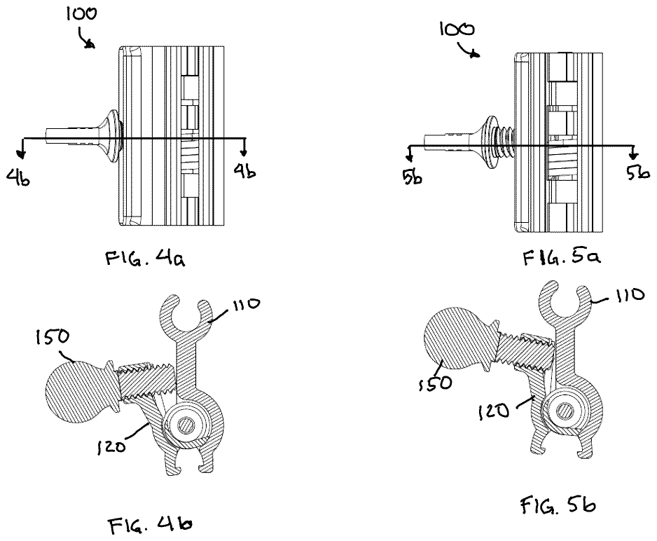

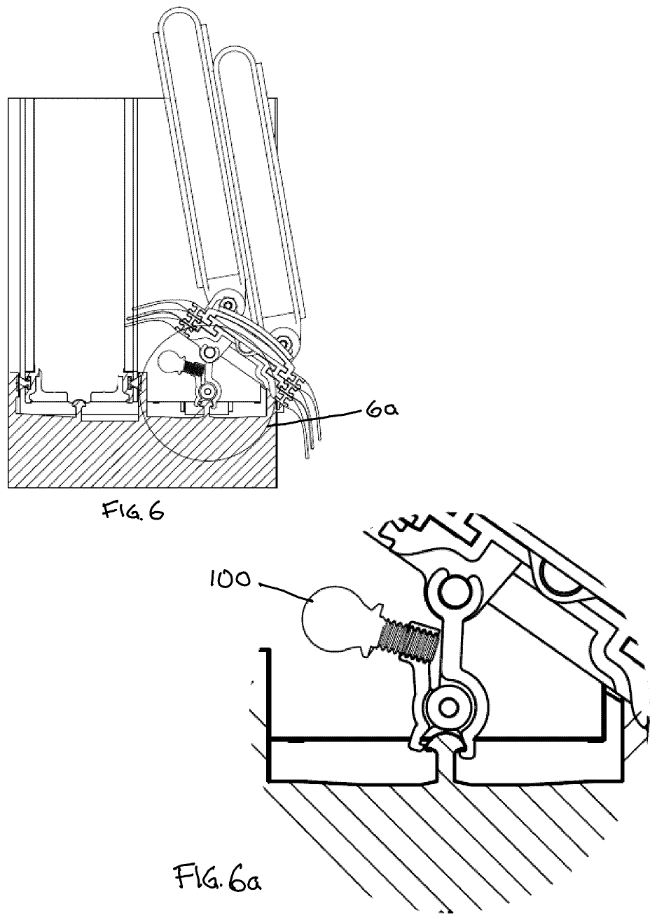

Referring now to the figures in general, and FIGS. 1-3, in particular, we disclose a preferred embodiment of a clip apparatus 100, according to an aspect of the invention. Clip apparatus 100 is comprised of a first clip half 110, a second clip half 120, and a receiver 160. The first clip half 110 and the second clip half 120 are pivotably connected to each other by pin 130. As shown in FIG. 3, both first clip half 110 and second clip half 120 have a jaw portion 111 and 121, respectively. The clip apparatus 100 may also additionally include at least one biasing element 140. The claim apparatus 100 may further optionally include at least one locking element 150.

In embodiments, therefore, the clip apparatus provides an attachment mechanism by which a rain deflector apparatus may be secured in relation to a sliding door track or similar structure. (See FIG. 6-6a.)

An embodiment of a clip apparatus 100 comprises: a jaw portion (as elements 111 and 121, combined) configured to be selectively positioned between an open aspect and a closed aspect, and releasably securable to a track extrusion (see FIG. 6-6a.); a receiver rail 160 distal to the jaw portion; a pivot axis 170 between the jaw portion and the receiver rail 160; a force biasing element 140 configured to maintain the jaw portion in the closed aspect; and a locking element 150.

### Clip Apparatus 200

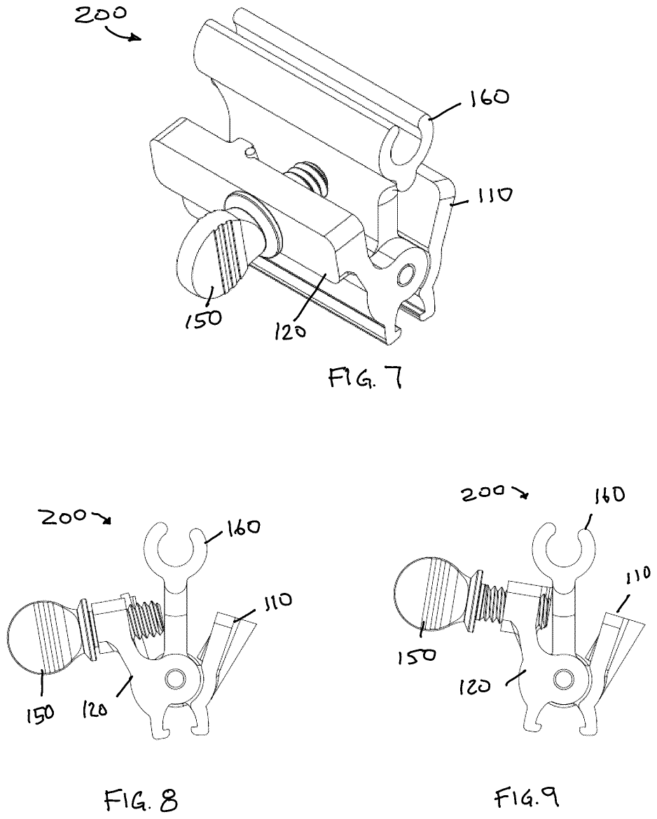

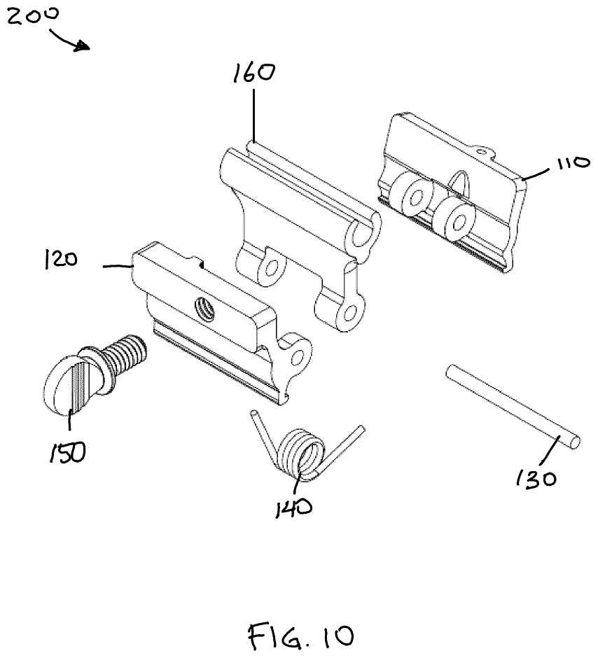

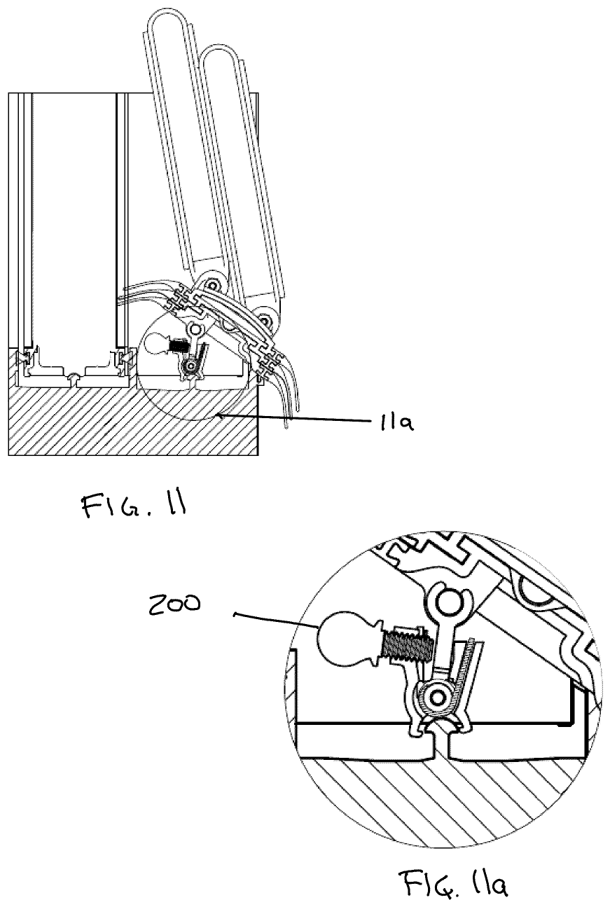

Another exemplary embodiment of the clip apparatus is shown in FIGS. 7-11a. Here, clip apparatus 200 is similarly configured with a first clip half 110, a second clip half 120, a pin 130, a biasing element 140, a receiver rail 160, and a locking element 150. In this embodiment, however, the receiver rail 160 is a separate component from the second clip half 120, affording additional aspects and advantages as may be desired in particular installation instances.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the disclosure. In particular, features from one embodiment can be used with another embodiment. The embodiments were chosen and described to best explain the principles of the disclosure and the practical application, and to enable others of ordinary skill in the art to understand the invention for various embodiments with various modifications as are suited to the particular use contemplated.

1. A clip apparatus comprising:
a jaw portion configured to be selectively positioned between an open aspect and a closed aspect, and releasably securable to a track extrusion;
a receiver rail distal to the jaw portion;
a pivot axis between the jaw portion and the receiver rail; and
a force biasing element configured to maintain the jaw portion in the closed aspect.

2. The clip apparatus of claim 1 further comprising a locking element.

3. The clip apparatus of claim 2 where the locking element is a thumb screw.

4. The clip apparatus of claim 1 where the force biasing element is a spring.

5. The clip apparatus of claim 4 where the spring is a torsion spring.

6. The clip apparatus of claim 1 where the jaw portion further comprises one or more lead in feature.

7. A clip apparatus comprising:
a first clip half;
a second clip half;
a pin;
a biasing element; and
a receiver rail.

8. The clip apparatus of claim 7 further comprising a locking element.

9. The clip apparatus of claim 7 where the first clip half and second clip half each include one or more interfacing knuckle portions having a coaxial bore therethrough, the coaxial bore configured to accept the pin in inserted relation.

10. The clamp apparatus of claim 7 where the biasing element is a torsion spring configured to maintain the clip apparatus in a closed position.

11. The clamp apparatus of claim 7 where the receiver rail is integral to the first clip half.

12. The clip apparatus of claim 7 where the first clip half and the second clip half each further comprise a lead in feature.
